(19) United States
(12) Patent Application Publication
(10) Pub. No.: US 2024/0140062 A1
(43) Pub. Date: May 2, 2024

(54) Pressing System and Pressing Tool for a Pressing System, as Well as Method for Manufacturing a Workpiece

(71) Applicant: Siempelkamp Maschinen- und Anlagenbau GmbH, Krefeld (DE)

(72) Inventors: Michael Schöler, Rheurdt (DE); Fabian Köffers, Krefeld (DE); Klaus Schürmann, Jüchen (DE); Georg Geier, Krefeld (DE); Jens Stellmacher, Krefeld (DE)

(21) Appl. No.: 18/277,820

(22) PCT Filed: Feb. 22, 2022
(86) PCT No.: PCT/EP2022/054333

§ 371 Date: Aug. 18, 2023

(30) Foreign Application Priority Data
Feb. 22, 2021 (DE) 10 2021 000 923.1

(51) Int. Cl. B30B 5/02; B21D 22/10; B30B 15/06

(52) U.S. Cl. CPC B30B 5/02; B21D 22/10; B30B 15/064

(57) ABSTRACT

The invention relates to a pressing system, including a press having a first pressing tool and a second pressing tool. The first pressing tool and the second pressing tool being movable relative to one another to form a working space. A workpiece, a pressure generating device for generating a pressure curve acting on the workpiece in the working space, a temperature generating device for generating a temperature curve acting on the workpiece in the working space the workpiece running through an elongation curve (DVW) depending on the pressure curve acting in the working space and on the temperature curve acting in the working space. The first pressing tool and the second pressing tool running through a respective elongation curve (DVP1, DVP2) depending on the pressure curve acting in the working space and on the temperature curve acting in the working space, wherein the first pressing tool and/or the second pressing tool are designed such that their elongation curve (DVP1, DVP2) deviates by no more than 3.5% from the elongation curve (DVW) of the workpiece during at least 97.5% of the elongation curve. The invention further relates to a pressing tool and to a method for producing a workpiece.

### CROSS-REFERENCE TO RELATED APPLICATIONS

This application is the United States national phase of International Application No. PCT/EP2022/054333 filed Feb. 22, 2022, and claims priority to German Patent Application No. 10 2021 000 923.1 filed Feb. 22, 2021, the disclosures of which are hereby incorporated by reference in their entireties.

### BACKGROUND OF THE INVENTION

### Field of the Invention

The invention relates to a pressing system comprising:
a press with a first pressing tool and a second pressing tool, wherein the first pressing tool and the second pressing tool can be moved relative to one another to form a working space
a workpiece
a pressure generating device for generating a pressure profile acting on the workpiece located in the working space
a temperature generating device for generating a temperature profile acting on the workpiece located in the working space
wherein the workpiece passes through an expansion profile as a function of the pressure profile acting in the working space and the temperature profile acting in the working space
wherein the first pressing tool and the second pressing tool pass through a respective expansion profile as a function of the pressure profile acting in the working space and the temperature profile acting in the working space.

The invention also relates to a pressing tool for use in a press.

The invention further relates to a method for manufacturing a workpiece.

### Discussion of the Related Art

Pressing systems and pressing tools have been known for a long time. In contrast to a casting system, a casting tool or a casting device, a pressing system, a press and a pressing tool are always referred to if the pressing system comprises at least two pressing tools arranged so as to be movable towards one another or if the press is suitable for receiving at least two pressing tools arranged so as to be movable towards one another, wherein a working space is enlarged or reduced by relative movement of the at least two pressing tools and wherein and the pressure acting on the workpiece to be machined is independent of a filling pressure of at least one material component of the workpiece.

In contrast to the press itself, the workpiece to be manufactured in the press is therefore also part of a pressing system, wherein, in the sense of the present text, machining of a workpiece should also be understood to mean the term “manufacturing”.

Accordingly, centrifugal casting, RTM (Resin Transfer Molding) or other processes and their arrangements are non-generic in comparison to the pressing system, the press and the pressing method underlying the invention, in which at least one (material) component of the workpiece to be produced is introduced in liquid form in the closed or at least substantially closed working space.

However, according to the prior art, the RTM method in particular is often used in different variants for the production of workpieces made of fibre composite materials, for example of carbon fibre-containing composite materials (CFRP), although the RTM method generally has significant disadvantages compared to a pressing method. Among other things, the achievable results in terms of homogeneity, quality and stability in such processes fall far short of those achievable with a pressing method.

Fibre composite materials are composite materials that consist substantially of two main components: reinforcing fibres and a plastic in which the fibres are embedded (“matrix” or “resin”). By combining the two main components, it can be achieved that the composite material as a whole has better properties than the two components alone. For example, due to their high tensile strength in the direction of the fibre, the fibres help to increase the tensile strength of the composite material. The matrix, on the other hand, ensures, for example, that the fibres are held in their position and are protected from mechanical and chemical influences.

However, the problem with pressing methods thus far is that different thermal expansion coefficients are set within the pressing systems consisting of the workpiece to be manufactured and the pressing tools acting on the workpiece during the pressing process. This phenomenon is well known. The person skilled in the art is aware that when cooling, either the pressing tool shrinks onto the workpiece or the workpiece onto the pressing tool.

Since composites with carbon fibre portions, in particular thermoplastics with embedded carbon fibre meshes, e.g. CFRP itself, have extremely low longitudinal or volume expansions (whereby in some cases there are strong differences in the direction of the fibre layer or at an angle thereto, in particular orthogonally thereto, which also applies in a significantly weakened form to glass reinforced plastic GRP, the manufacture of workpieces made of CFRP in a pressing process is particularly difficult. In contrast to their extremely low thermal expansion behaviour, such composites accordingly hardly withstand forced expansion at least during their thermal manufacturing or processing process, at least not without undesired changes to their matrix, which is so important for later use. In addition, unwanted air inclusions may occur, which significantly reduces the achievable durability.

In particular, if so-called “prepregs” or “organo sheets” are to be processed in a temperature-controlled processing process, the thermal expansion behaviour of the pressing tools or the pressing dies can easily represent the decisive limit of the processing possibilities, since the pressing tools or the pressing dies themselves must be correspondingly temperature-resistant. In addition, they must be designed to be economically usable and accordingly designed for long service lives. Furthermore, the pressing tools or the pressing dies must be manufacturable with suitable accuracy and their surfaces must be easy to polish such that they have so far been manufactured from steel practically without an alternative.

Therefore, as already mentioned above, many CFRP components are still cast in so-called RTM processes today instead of being pressed out of prepregs, even if this entails the disadvantages already described above.

If, for example, only one pressing tool or die part experiences a length or volume change which differs from the length or volume change of the prepregs or organo sheets or in general of the workpiece to be produced or machined, at least carrier layer portions undergo displacements at least in areas, internally or reaching up to a surface and as a result often at least structural portions also break and can therefore no longer maintain the planned structural strength.

This is in particular problematic when designing large workpieces, as different wall thicknesses can hardly be prevented here and different cooling rates occur in areas depending on the wall thickness. Large workpieces also have correspondingly large effective lever lengths. A distortion of a few tenths of a degree can be felt in a large workpiece of over 3 m or even over 5 m in length, for example, and is significantly more disturbing than in a workpiece of normal dimensions, with maximum lengths of a few centimetres to around one or a half metres.

This means that warping and damage to the workpiece to be manufactured can occur very easily. As a result, the reject rate increases or the post-processing effort increases. In some cases, however, it may also be impossible to manufacture large workpieces that are as single-piece as possible due to the occurrence of structural damage due to arising stresses. The greater the maximum length(s) of a large workpiece, the more serious this problem becomes.

In order to be able to press such large components at all with sufficiently uniform pressure, pressing devices and methods are known which apply hydrostatic pressure on one side via a membrane to the workpiece resting against a fixed tool.

An example of this is the device known from DE 10 2017 113 595 A1 and the method for manufacturing components made of fibre composite material. Uniform pressurisation of the part to be manufactured should be achieved by a flexible membrane acting on the part, wherein an oil pressure acts on the membrane from the side of the membrane facing away from the part. The membrane is therefore pressed onto the part surface by an oil pressure. In this manner, it should also be ensured in the case of curved part surfaces that the oil pressure acts on all sides and thus the force acting from the membrane on the part surface is the same at all points, in particular also the force component acting orthogonally on the part surface.

The use of such a “membrane press” for manufacturing parts from fibre composite material is also known from US 2016/0297153 A1.

One challenge of using a membrane is that, during the entire manufacturing process, the membrane must have a surface that is as smooth as possible in order to ensure a uniform transfer of pressure to the part surface. At the same time, the membrane must be reliably sealed against the cavity in which the oil pressure is built up, but still be stored in a movable manner in order to maintain its smooth surface, even during heat-induced expansion or contraction.

Nevertheless, even in the case of such pressing devices, methods or systems, the fundamental problem of thermal expansion behaviour occurring differently within the pressing system, in particular of the pressing tool(s) with respect to the workpiece(s), remains unresolved.

Against this background, the object underlying the invention is to provide a pressing system with which high-quality workpieces can be manufactured in thermally guided pressing processes.

In particular, it should be possible to manufacture workpieces with high structural strength, even if the workpieces are to be manufactured from materials and/or material mixtures which have particularly low thermal expansion coefficients.

In addition, damage to the structural design of the workpiece to be manufactured should be avoided or at least reduced.

### SUMMARY OF THE INVENTION

At least one of these objects is achieved in a pressing system of the type mentioned at the outset in that the first pressing tool and/or the second pressing tool are designed in such manner that their expansion profile deviates by a maximum of 3.5% from the expansion profile of the workpiece during at least 97.5% of the expansion profile.

The expansion profile thereby corresponds to the expansion value applied over a time period. In deviation from previous approaches, the invention therefore does not assume that only the maximum amounts of thermally-induced expansions between two materials interacting with one another, in this case the pressing tool material and the workpiece material, are to be compared, but rather their profiles, and these are to be narrowly limited to a maximum of 3.5% temporary difference.

The inventors have recognised that it is not expedient to adjust the maximum expansion values, since the expansion behaviour of different materials, in particular of composite materials, is not linear.

Another common misconception is that the expansion behaviour alone depends on the material.

According to the invention, the first pressing tool and the second pressing tool are designed in such manner that their expansion profile deviates by a maximum of 3.5% from the expansion profile of the workpiece during at least 97.5% of the expansion profile, wherein the deviation from the expansion profile corresponds to the deviation of the expansion value at the same time within a time period, then preferably defined by the pressing process.

The expansions or expansion profiles of the pressing tools and the workpiece can be determined directly (by measurement) or indirectly (calculated/simulatively) during the pressing process. Contact or contactless measuring methods can be used for the measurement determination, for example optical measuring methods with image processing and image evaluation. In contrast, in the case of the computational determination, measurement variables are to be recorded from which the expansion profile is computationally determined taking into account known coefficients. These measurement variables include, in particular, the temperature or the temperature profile and/or the pressure or the pressure profile. These measurement variables can also be determined in a contact or contactless manner (e.g. temperature determination by measuring infrared radiation). The relevant coefficients include, in particular, the expansion coefficient, which depends on the material used. Furthermore, factors such as the volume of a component, the surface of a component, the temperature absorption capacity of a component and form coefficients can be used in the computational determination. When determining the temperature of the pressing tools and the workpiece, the determined temperature of a cooling or heating medium flowing through the pressing system can also be used if heat transfer or heat transport takes place in between. In order to determine the expansions or expansion profiles of the pressing tools and the workpiece as precisely as possible, the highest possible frequency measurement and/or calculation methods should be used. The measured or determined expansion profiles can be used to control them, for example by adjusting the temperature during the pressing process.

It is particularly preferred in this case that the expansion profile of the first pressing tool and the second pressing tool during at least 98.0% of the expansion profile only deviates by a maximum of 3.0% from the expansion profile of the workpiece or even during at least 98.5% of the expansion profile by only a maximum of 2.5% from the expansion profile of the workpiece.

Such a pressing system is therefore particularly well suited for the manufacture of components made of fibre composites based on the use of prefabricated fibre-resin semi-finished products (so-called “prepregs”, abbreviation of “preimpregnated fibres”). In the case of such semi-finished products, the fibres are provided with a resin system that has not yet reacted completely, so that the semi-finished products are still present in a flexible form (e.g. web-shaped, on rollers or plate-shaped). The prepregs are only reshaped when the parts are manufactured and hardened at high pressure and high temperatures by completing the chemical reaction. This step can then be carried out with great advantage in the present pressing system.

Accordingly, it is preferred for the workpiece to comprise at least one first component and at least one second component.

In this way, particularly stable workpieces can be produced and the advantages of the pressing system can be used even if only one of the two material components is usually sensitive to expansion deviations.

It is particularly advantageous if the first component and the second component connect within the working space during a pressing process under the influence of pressure and temperature.

This means that workpieces of particularly high quality can be produced, whereby the use of this pressing system means that there is no longer any need to fear any displacements, weakening or over-expansion that are effective in practice. This applies, in particular, if the first component is formed by fibres, for example in the form of a fibre braid, in particular a carbon fibre braid and the second component in the form of a bedding matrix, in particular a resin.

For example, a mixture of these two components is represented by the already mentioned prepregs.

For example, prepregs are processed in large quantities in the aviation industry. A challenge in processing is that the aerospace industry often requires very complex part geometries, for example due to reinforcement elements such as stringers. In addition, the assembly work should be reduced, which should be achieved by using fewer, but larger parts. The combination of complex geometries and large part dimensions places increased demands on devices and processes for the manufacture of these parts. One requirement, for example, is to ensure uniform pressurisation during the manufacture of the parts.

It is therefore also particularly advantageous if the pressing system further comprises a membrane, wherein the membrane is connected to one of the pressing tools, wherein a cavity for a working medium is formed between the membrane and the pressing tool connected thereto.

As a result, hydrostatic pressure acts on the workpiece during the pressing process; in other words, the workpiece is reliably subjected to the same pressure in all regions.

Fluctuations that form in areas can thereby also be compensated by adding thickness tolerances to prepreg sheets or plates arranged on top of one another.

If the membrane is already pretensioned before closing the press, it is ensured that it has a smooth surface at the beginning of the action on the workpiece and is not put under stress only by the working medium in the cavity and is thus “smoothly pulled”. This has the advantage that the membrane is applied evenly to the workpiece at the beginning of the temperature and pressure application.

Corresponding to at least part of the aforementioned advantages, it is in some cases preferred if the membrane is designed in such manner that its expansion profile also deviates by a maximum of 3.5% from the expansion profile of the workpiece during at least 97.5% of the expansion profile.

However, since this severely restricts the design possibilities of the membrane, in other cases it may in turn be preferred if the membrane is designed in such manner that its expansion profile deviates by more than 5.0% from the expansion profile of the workpiece during at least 5.0% of the expansion profile.

Many aspects must be taken into account when designing the membrane. On the one hand, the membrane should be designed to be as flat as possible in order to be able to transfer temperature quickly. For this purpose, it can be designed to be temperature-controlled by the medium, in particular oil, stored at least temporarily in the cavity. In addition, however, the membrane must be able to withstand high tensile loads so that production from a sheet steel with thicknesses of between 0.9 mm and 4.2 mm, in particular of between 1.5 mm and 3.0 mm, is preferred.

In addition, the surface of the membrane is transferred to a surface of the workpiece. For this purpose, it may be desired for the membrane to be designed to be particularly smooth or structured according to a specific pattern repeating in areas or to generate a specific individual image, for example in the form of a relief.

In addition, it may be desired on a case-by-case basis that the membrane must be designed magnetically.

In order to have sufficient design possibilities, it is desirable if the membrane does not need to be particularly restricted in terms of its expansion behaviour.

Instead, it can be advantageously provided that the pressing system has a pressing plane and that the membrane is arranged so as to be movable with respect to the pressing tool connected thereto, preferably with at least one directional component, preferably running substantially parallel to the pressing plane.

For this purpose, it can be advantageously provided that the membrane, preferably by applying pressure and/or temperature to the membrane, preferably by means of a working medium in the cavity, by which it can be passed with respect to the seal sealing the pressing tool and preferably that the membrane, due to its, in particular temperature-induced, expansion occurring within the pressing process in connection with expansion force, is passed by the seal at least in sections.

It is preferred that at least the first pressing tool and/or at least the second pressing tool comprises a cast iron material with a nickel content of between 36.0% and 48%, preferably between 37.5% and 47%, quite preferably of between 39.25% and 46%, and is formed in particular at least 90% by volume fraction, %, in particular at least 98%, preferably integrally, therefrom.

This has the advantage that the cast iron material is cooled from the authentic crystal lattice and, in the temperature range from −60° C. to 440° C., in particular in the temperature range from 0° C. to 420° C., has an extremely small volume and length change (in the positive direction: volume or longitudinal expansion). It is also advantageous that the volume change behaviour of such a cast iron material is at least within the stated temperature ranges, is largely in line with that of CFRP materials and can be precisely adjusted to individual CFRP material compositions depending on the precise determination of the nickel content to be selected within these limits. In addition, the thermal conductivity of cast iron material is significantly better than that of cast steel due to the precipitated carbon in the form of graphite, such that a more favourable behaviour of the component is achieved in the thermal process.

It is thereby quite particularly advantageous that the volume change behaviour of such a cast iron material is very similar to that of a GRP material and in particular to that of a CFRP material. Surprisingly, this applies not only to the absolute value in relation to a temperature difference to be overcome, for example specified by a process, but rather, completely differently to alloys of other application areas manufactured for comparable purposes, also applies to the entire course of the length and/or volume change. This is the only way to achieve the goal of minimising or preventing microscopic or macroscopic displacements within the forming workpiece structure.

In addition, the alloy as a cast iron material has significant advantages over a cast steel material alloy: Due to the precipitation of the dissolved carbon from the melt during the solidification process, a composite material is ultimately formed with the cast iron. This precipitation process, which is associated with a volume change in the material, has a favourable effect on the shrinkage behaviour of the cast iron compared to the cast steel. This then leads to a lower shrinkage behaviour, which ultimately also leads to lower shrinkage cavity formation and the existence of a significantly more definite behaviour in itself—especially with regard to the progression of the length or volume change behaviour under temperature influence. In addition, parts to be produced therefrom can be produced more easily in solid quality in terms of process technology, which ultimately also has an economic advantage. At the same time, no further heat treatment is often necessary, in contrast to cast steel, which is regularly subjected to a heat treatment following the original solidification process, which offers not least considerable economic advantages, in particular for large parts, for example for pressing tools for large workpieces.

It is also important that a cast iron material enables a significantly more dampened vibration behaviour of a pressing tool compared to a cast steel material. This is particularly important because the cycle time in which a pressing system opens and closes again, but also the closing time (and of course the opening time) can be decisive for economically successful use of the pressing system.

With this in mind, it is therefore also particularly preferred for the cast iron material to comprise 1.0% to 5.5%, preferably 1.5% to 4.0% carbon.

The cast iron material is particularly preferably characterised as follows: Cast iron material, which comprises at least the following proportions in percentage by weight as elements or compounds of:

Carbon in the range from approx. 1.0% to 4.0%, silicon in the range from approx. 1.0% to 5.0%, manganese in the range from approx. 0.1% to 1.5%, nickel in the range from approx. 36.5% to 48.0%, chromium in the range from approx. 0.01% to 0.25%, phosphorus up to approx. 0.08%, copper up to approx. 0.5%, magnesium up to approx. 0.15%, wherein the remainder comprises iron. The cast iron material can also have a proportion of magnesium in the range of approx. 0.020% to 0.150%, preferably from approx. 0.040% to 0.100%, particularly preferably from approx. 0.065% to 0.090%.

Furthermore, the cast iron material can comprise a proportion of silicon in the range of approx. 1.0% to 4.5%, preferably from approx. 1.0% to 2.5%, particularly preferably from approx. 1.3% to 2.0%.

Preferably, the pressing system passes through a pressing cycle to manufacture the workpiece and the pressing cycle passes through a temperature difference of 100 K to 500 K, preferably of 170 K to 450 K, quite preferably of 190 K to 250 K, acting in the working space.

The pressing cycle, which in addition to the actual pressing process also comprises the opening and closing of the press, should therefore pass through a temperature difference of at least 100 K (1K=1 degree Kelvin) at least once. However, the temperature difference should not exceed 500 K.

The mentioned range, but also the preferred ranges within this range, should generally thereby start from an ambient or room temperature depending on the season and local environment, i.e. normally from −20° C. to +45° C.

This temperature window is sufficient and appropriate for most thermally controlled processes for the manufacture of workpieces, in particular made of CFRP or GRP.

It is also advantageous if the working space is defined by a first spatial axis, a second spatial axis and a third spatial axis and is designed at least in the direction of one of the spatial axes along a distance of at least 1.3 m, preferably at least 3.5 m, quite preferably at least 5 m, more preferably at least 8 m and quite particularly preferably at least 10.5 m.

In this way, workpieces with large installation lengths, e.g. body parts for vehicles, in particular cars, trucks, aircraft, boats and ships, but also rotor blades for wind turbines or similarly large workpieces, can be manufactured.

For large workpieces, the aforementioned advantages of the pressing system come into their own particularly well.

In a pressing tool for use in a press with a first pressing tool and a second pressing tool, wherein the first pressing tool and the second pressing tool can be moved relative to one another to form a working space, and wherein the pressing tool is designed in such manner that it can be brought into operative connection with a pressure generating device to generate a pressure profile acting on the workpiece located in the working space and a temperature generating device to generate a temperature profile acting on the workpiece located in the working space, at least one object underlying the invention is achieved in that the pressing tool is configured for a pressing system as described herein.

The associated advantages are apparent to the person skilled in the art from the part of the present patent application describing the pressing system and apply accordingly here. Of course, the pressing tool is therefore not only intended for use in a press, but also for use in a pressing system.

In a method for manufacturing a workpiece, comprising the following steps: providing a press with a pressure generating device and a temperature generating device; providing a workpiece (to be produced); inserting the workpiece into a working region to form a pressing system; closing the press;
applying pressure and/or temperature to the workpiece; opening the press; at least one of the objects underlying the present invention is achieved by
the workpiece passing through an expansion profile as a function of the pressure profile acting in the working space and the temperature profile acting in the working space,
wherein the first pressing tool and the second pressing tool pass through a respective expansion profile as a function of the pressure profile acting in the working space and the temperature profile acting in the working space and the first pressing tool and/or the second pressing tool are designed in such manner that their expansion profile deviates by a maximum of 3.5% from the expansion profile of the workpiece during at least 97.5% of the expansion profile.

In this case, it is preferred for a pressing system according to any one of the associated claims to be used to carry out the method.

Furthermore, it is thereby preferred that the forming workpiece is inserted into the press, in particular into the working space, in the form of a plurality of prepregs in a fixed aggregate state.

The advantages associated with the method according to the invention and/or its preferred configurations are apparent to the person skilled in the art from the part of the present patent application describing the pressing system and apply accordingly here.

### BRIEF DESCRIPTION OF THE DRAWINGS

The invention will be explained in greater detail below on the basis of a drawing merely depicting a preferred exemplary embodiment, in which is shown:

FIG. 1A: a first configuration of a press for carrying out a method according to the invention in the cross-section in an open position without an inserted workpiece,

FIG. 1B: the press from FIG. 1A in an open position with inserted workpiece,

FIG. 1C: the press from FIG. 1A in a closed position,

FIG. 2: expansion profiles

FIG. 3: the sequence of a method according to the invention in a schematic representation.

### DESCRIPTION OF THE INVENTION

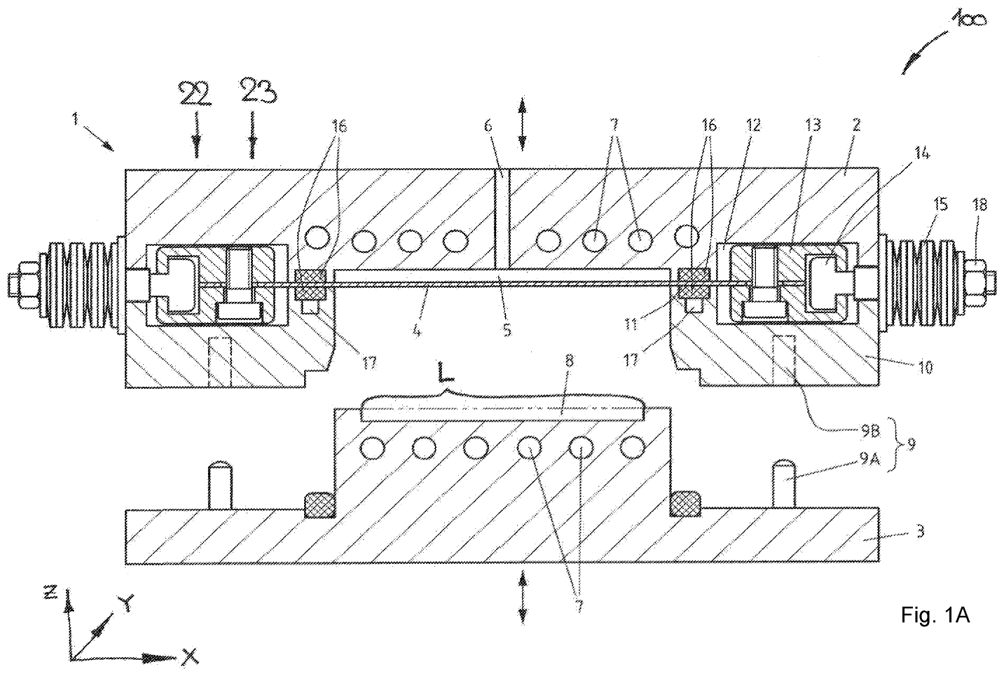

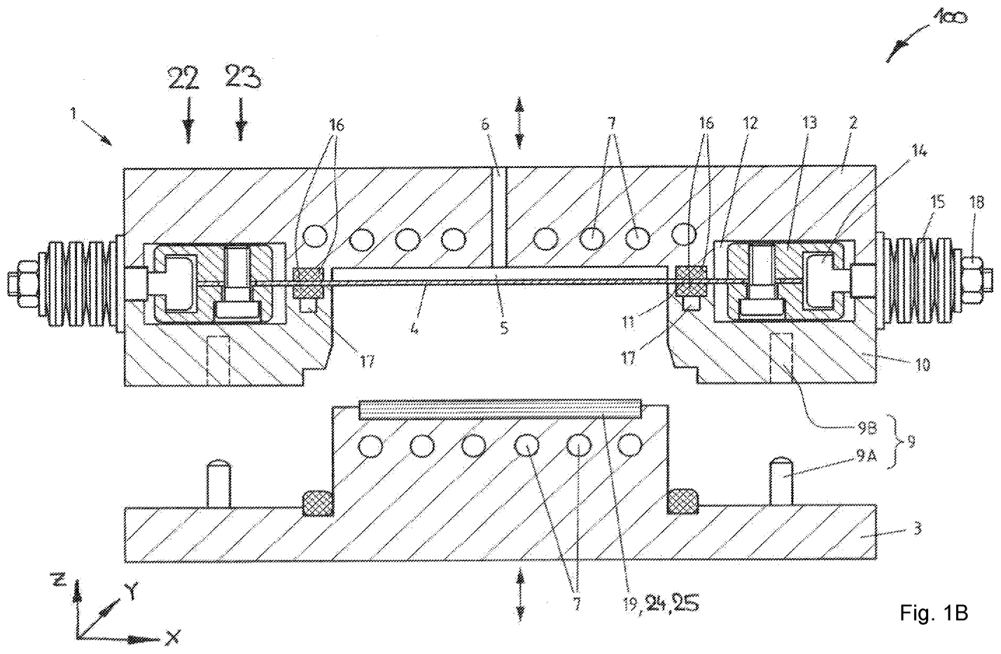

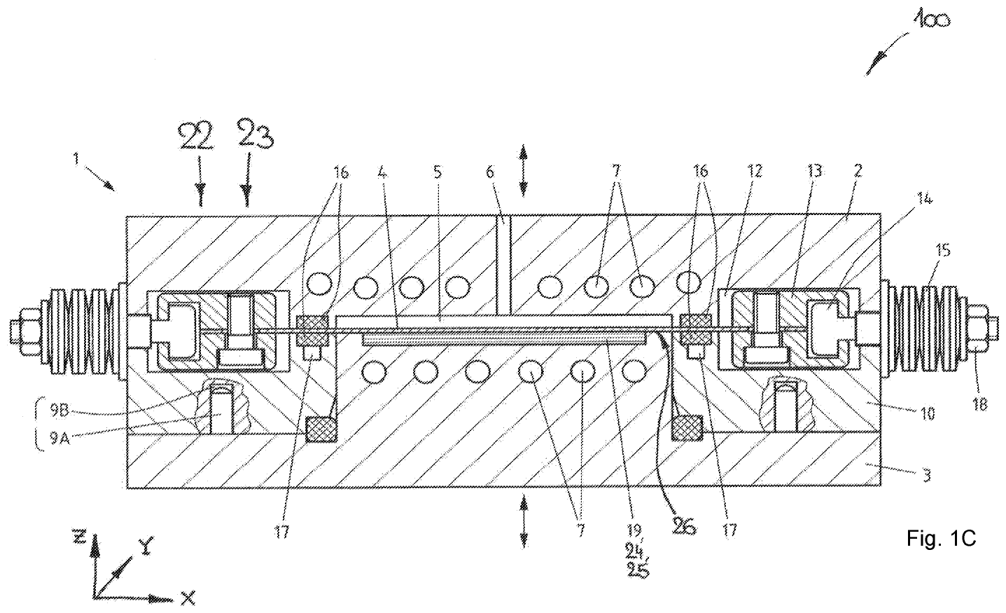

FIG. 1A shows a first configuration of a press 1 for forming a pressing system 100 and for carrying out a method according to the invention for manufacturing a workpiece 19, in the cross-section in an open position without an inserted workpiece 19. The press 1 comprises a first, upper pressing tool 2 and a second, lower pressing tool 3. The two pressing tools 2, 3 can be moved relative to one another, for example in the vertical direction (Z direction) (indicated by arrows in FIG. 1). In addition, the press comprises a membrane 4 which is connected to the upper pressing tool 2. As an alternative to the configuration shown in FIG. 1, the membrane 4 could also be connected to the lower pressing tool 3. In a further alternative configuration, a second membrane could also be provided in addition to the membrane such that both the first and the second tool would be connected to a membrane. Furthermore, it would be conceivable for a single membrane to be connected both to the first pressing tool 2 and to the second pressing tool 3 and for this to preferably be arranged deflected, for example by 180°.

A cavity 5 for a working medium, for example oil, is formed between the membrane 4 and the upper pressing tool 2 connected thereto. The membrane 4 is manufactured from metal and preferably has a thickness in the range of between 0.05 mm and 3.5 mm, but preferably between 0.2 mm and 2.2 mm. The cavity 5 can be filled with the working medium via a channel 6. Bores 7 are provided both in the upper pressing tool 2 and the lower pressing tool 3 through which a heating and/or cooling medium can be guided.

In the configuration of the press 1 shown in FIG. 1A, a working space 8, in which a workpiece 19 (not shown in FIG. 1A) can be inserted, is provided in the lower pressing tool 3. Deviating from this, a part of the working space can also be formed by the second pressing tool 3. However, since the workpiece 19 represented in FIGS. 1B and 1C should preferably be formed from a first component 24 and a second component 25, which are connected to one another during a pressing process within the working space 8 under the influence of pressure and temperature, it is advantageous if the free space provided for forming the working space 8 is provided in the lower pressing tool 3. The two pressing tools 2, 3 have a guide 9 which can for example be formed by a protrusion 9A and a recess 9B, wherein the protrusion 9A can be provided on the lower pressing tool 3 and wherein the recess 9B can be provided on the upper pressing tool 2. The action of the pressure generating device 22 and the temperature generating device is indicated by arrows. Of course, it is preferred that the temperature generating device 23 also acts on both pressing tools 2 and 3, while the pressure generating device 22 automatically affects all components delimiting the working space 8 when the press is closed. In particular, the pressure generating device can also act on the cavity 5 delimited by the membrane 4, at least with a part of its output.

The membrane 4 is connected to the upper pressing tool 2 in the following manner: The upper pressing tool 2 has a circumferential edge element 10, which is screwed to the upper pressing tool 2 (the screw connection is not represented in FIG. 1A). A gap 11 is formed between the upper pressing tool 2 and its edge element 10 through which the membrane 4 is guided. The gap 11 opens into a hollow space 12 in which a clamping device 13 is provided in which the membrane 4 is clamped. The clamping device 13 is connected to a tension anchor 14, which is led out of the upper pressing tool 2 and the edge element 10 through an opening and is pressed outwards there by a spring 15 supporting itself on the outer surface, whereby the membrane 4 is provided with pretension. In order to seal the cavity 5, a seal 16 is provided in the gap 11, which allows movement of the membrane 4. A device 17 for changing the sealing force F_{D} is provided adjoining the seal 16. A device 18 for changing the spring force F_{F} is provided adjoining the spring 15.

FIG. 1B shows the press 1 from FIG. 1A in an open position with inserted workpiece 19. The regions of the press 1 that have already been described are provided in FIG. 1B with corresponding reference numerals. The difference with the position shown in FIG. 1A is that the workpiece 19 (to be formed) has been inserted into the working space 8 of the lower pressing tool 3.

In this case, the workpiece 19, which is preferably still to be formed, consists of a first component 24 and a second component 25, which are stacked on top of one another in the form of so-called prepregs or organo sheets in a plurality of thin layers. The individual prepregs thereby have thicknesses of 0.12 mm to 0.72 mm, preferably 0.16 mm to 0.32 mm, and consist of fibre, in particular carbon fibre, braids inserted into a matrix of resin.

The chemical bond between the matrix (resin) and the fibres, or the fibre braid, is thereby only completed within the pressing system 100, i.e. during a pressing cycle, under the influence of pressure and temperature.

FIG. 1C shows the press 1 from FIG. 1A in a closed position. The regions of the press 1 that have already been described are also provided in FIG. 1C with corresponding reference numerals. The press 1 has been closed by moving the two pressing tools 2, 3 towards one another. In the position shown in FIG. 1C, pressure and temperature are applied to the workpiece 19. Pressurisation is carried out by guiding a working medium, for example oil, through the channel 6 into the cavity 5, whereby the membrane 4 is pressed in the direction of the workpiece 19. Alternatively, the cavity 5 can also already be filled with the working medium. In this case, the working medium can be stored against a pressure-limiting valve in the cavity and already pretensioned. When the press is closed, the pressure of the working medium within the cavity can then increase and thus also be exerted in response to the (forming) workpiece. The pressure of the working medium can then, for example, increase from a pretension range of between 1.2 bar and 2.5 bar to a working range of between 16 bar and 50 bar when closing the press 1, 1′, and in extreme cases even up to 70 bar and be maintained at this level for a pressing duration.

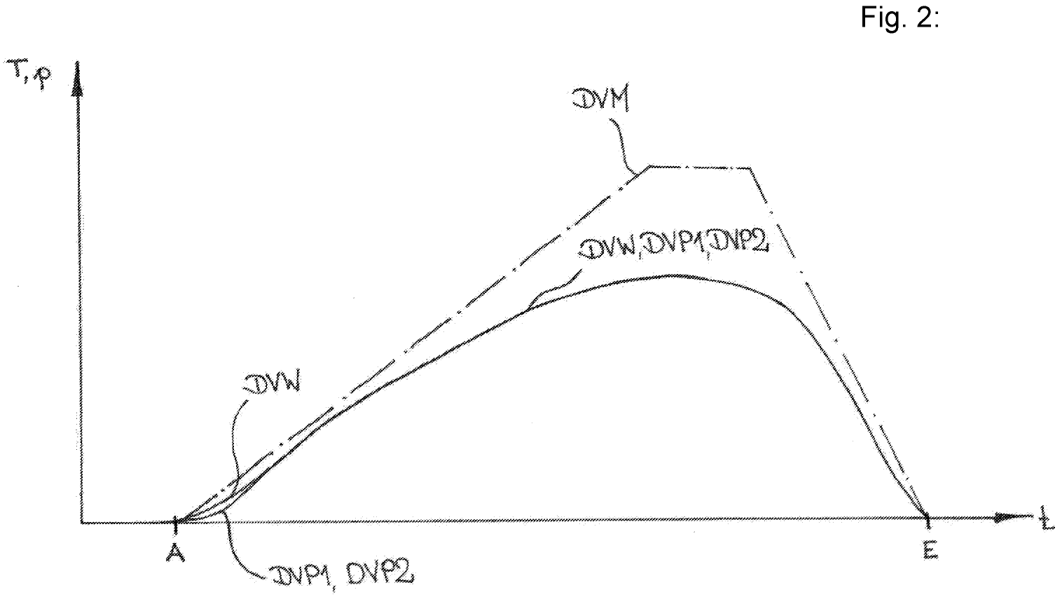

The application of temperature can take place in different ways: One possibility is to heat the working medium guided into the cavity 5 through the channel 6 such that the heat is transferred from the working medium located in the cavity 5 through the membrane 4 to the workpiece 19. Conversely, the working medium could be cooled in order to cool the workpiece 19. Alternatively or additionally to this, it can be provided that the bores 7 are flowed through by a heating and/or cooling medium, whereby first the two pressing tools 2, 3 and subsequently also the workpiece 19 can be heated or cooled. As a result of the pressure application, the workpiece 19 is compressed in the position shown in FIG. 1C. The represented pressing system 100 comprising: a press 1, with a first pressing tool 2 and a second pressing tool 3, wherein the first pressing tool 2 and the second pressing tool 3 can be moved relative to one another to form a working space 8, a workpiece 19, a pressure generating device 22, to generate a pressure profile acting on the workpiece 19 located in the working space 8, a temperature generating device 23 for generating a temperature profile acting on the workpiece 19 located in the working space 8, wherein the workpiece 19 passes through an expansion profile DVW represented in FIG. 2 as a function of the pressure profile acting in the working space 8 and the temperature profile acting in the working space 8, wherein the first pressing tool 2 and the second pressing tool 3 pass through a respective expansion profile DVP1, DVP2 also represented in FIG. 2 as a function of the pressure profile acting in the working space and the temperature profile acting in the working space 8, is characterised here in that the first pressing tool 2 and/or the second pressing tool 3 are designed in such manner that their expansion profile DVP1, DVP2, as can be seen in FIG. 2, deviates by a maximum of 3.5% from the expansion profile DVW of the workpiece 19 during at least 97.5% of the expansion profile.

The pressing system 100 thus passes through a pressing cycle to manufacture the workpiece 19. The pressing cycle can in this case pass through a temperature difference of 100 K to 500 K, preferably of 170 K to 450 K, quite preferably of 190 K to 250 K, acting in the working space 8, wherein, during the entire pressing cycle, it applies that the expansion profile DVP1, DVP2 deviates by a maximum of 3.5% from the expansion profile DVW of the workpiece 19 during at least 97.5% of the expansion profile.

For this purpose, the first pressing tool 2 and/or the second pressing tool 3 is preferably formed from a cast iron material which comprises a nickel content of between 36.0% and 48%, and is formed in particular at least 90% by volume fraction, preferably integrally, therefrom.

The cast iron material further comprises 1.0% to 5.5%, preferably 1.5% to 4.0% carbon and is preferably characterised as follows: Cast iron material, which comprises at least the following proportions in percentage by weight as elements or as compounds of: Carbon in the range from approx. 1.0% to 4.0%, silicon in the range from approx. 1.0% to 5.0%, manganese in the range from approx. 0.1% to 1.5%, nickel in the range from approx. 36.5% to 48.0%, chromium in the range from approx. 0.01% to 0.25%, phosphorus up to approx. 0.08%,

copper up to approx. 0.5%, magnesium up to approx. 0.15%, wherein the remainder comprises iron. The cast iron material can also have a proportion of magnesium in the range of approx. 0.020% to 0.150%, preferably from approx. 0.040% to 0.100%, particularly preferably from approx. 0.065% to 0.090%. Furthermore, the cast iron material can comprise a proportion of silicon in the range of approx. 1.0% to 4.5%, preferably from approx. 1.0% to 2.5%, particularly preferably from approx. 1.3% to 2.0%.

The working space 8 of the pressing system 100 represented in FIG. 1A to 1C and FIG. 2 is defined by a first spatial axis X, a second spatial axis Y and a third spatial axis Z, and is designed at least in the direction of one of the spatial axes X, Y, Z along a distance L of at least 1.3 m, preferably at least 3.5 m, quite preferably at least 5 m, more preferably of at least 8 m and quite particularly preferably of at least 10.5 m.

FIG. 2 shows the time course of a pressing cycle of the pressing system 100 along the horizontal axis. The expansion values are plotted over time along the vertical axis such that the expansion profiles DVM, DVW, DVP1 and DVP2 result as curves, the values of which are in each case dependent on the action of the pressure profile acting in the working space and the temperature profile acting in the working space. In this case, the pressing tools 2 and 3 experience the pressure and temperature profiles acting in the working space, but at least the temperature profile acting in the working space only secondarily, since it is not one of the tasks of a pressing system 100 to thermally load as many system parts as possible. From an ecological and economic point of view, this would be a mistake. Nevertheless, the expansion profiles DVP1 and DVP2 of the two pressing tools 2 and 3 deviate by a maximum of 3.5% from the expansion profile of the workpiece 19 over at least 97.5% of their expansion profile. In fact, apart from a small time delay, which is even insignificantly enlarged here for better visibility, and lasts up to a maximum of 1%, but at the extreme up to a maximum of 2% of the pressing cycle time and in which the maximum difference in the expansion behaviour between DVP1 or DVP2 to DVW is still below 1.5%, the curves lie practically permanently exactly on top of each other during the entire process cycle time and are therefore also represented on the same line in the further course of t.

In contrast, FIG. 2 also clearly shows that the expansion profile of the membrane 4 deviates by more than 5% from the expansion profile of the workpiece at the same time during at least 7.5% of its expansion profile.

The expansion behaviour of membrane 4 is also much more linear. Of course, the expansion profile curves of the workpiece and the pressing tools can also take on different curve shapes. It remains decisive that the first pressing tool 2 and/or the second pressing tool 3 are designed in such manner that their expansion profile DVP1, DVP2 deviates by a maximum of 3.5% from the expansion profile DVW of the workpiece 19 during at least 97.5% of the expansion profile.

The greater drop in curves shown in the represented example depends on the rapid cooling of the selected pressing process. In principle, however, the heating and cooling rates can also be equivalent. On a case-by-case basis, it is also conceivable that the heating process will be run faster than the cooling process. As represented, a holding part is normally provided between the heating and cooling process portions in which the pressure and temperature are kept at one level. The expansion behaviour then adjusts in general, but can creep slightly and therefore assume a slightly rounded shape, which is also depicted somewhat exaggerated.

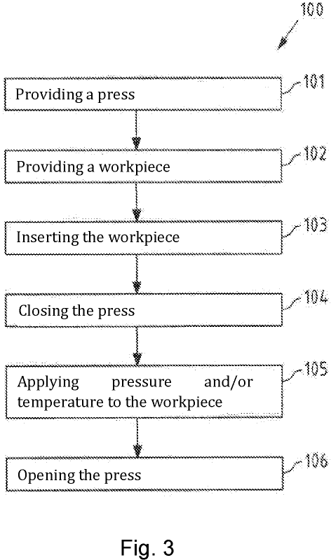

FIG. 3 finally shows the sequence of a method 100 according to the invention in a schematic representation. The method 100 comprises the following steps: 101: Providing a press, 102: Providing a workpiece, 103: Inserting the workpiece, 104: Closing the press, 105: Applying pressure and/or temperature to the workpiece, 106: Opening the press.

### LIST OF REFERENCE NUMERALS

1, 1′: Press
2: First (upper) pressing tool
3: Second (lower) pressing tool
4: Membrane
5: Cavity
6: Channel
7: Bore
8: Working space
9: Guide
9A: Protrusion
9B: Recess
10: Edge element
11: Gap
12: Hollow space
13: Clamping device
14: Tension anchor
15: Spring
16, 16′: Seal
17, 17′: Device (for changing the sealing force F_{D})
18: Device (for changing the spring force F_{D})
19: Workpiece
22: Pressure generating device
23: Temperature generating device
24: First component
25: Second component
26: Pressing plane
100: Pressing system
A Start of the pressing cycle
E End of pressing cycle
DVM: Expansion profile of the membrane
DVP1: Expansion profile of the first pressing tool
DVP2: Expansion profile of the first pressing tool
DVW: Expansion profile of the workpiece
L: Distance
p: Pressure
t: Time
T: Temperature
X: First spatial direction (longitudinal direction)
Y: Second spatial direction (width direction)
Z: Third spatial direction (vertical direction)

1-15. (canceled)

16. A pressing system including:
a press with a first pressing tool and a second pressing tool, wherein the first pressing tool and the second pressing tool can be moved relative to one another to form a working space,
a workpiece
a pressure generating device for generating a pressure profile acting on the workpiece located in the working space
a temperature generating device for generating a temperature profile acting on the workpiece located in the working space
wherein the workpiece passes through an expansion profile (DVW) as a function of the pressure profile acting in the working space and the temperature profile acting in the working space
wherein the first pressing tool and the second pressing tool pass through a respective expansion profile (DVP1, DVP2) as a function of the pressure profile acting in the working space and the temperature profile acting in the working space, wherein the first pressing tool and/or the second pressing tool are designed in such manner that their expansion profile (DVP1, DVP2) deviates by a maximum of 3.5% of the expansion profile (DVW) of the workpiece during at least 97.5% of the expansion profile.

17. The pressing system according to claim 1, wherein the workpiece comprises at least one first component and at least one second component.

18. The pressing system according to claim 2,
wherein the first component and the second component connect to one another during a pressing process within the working space under the influence of pressure and temperature.

19. The pressing system according to claim 16, wherein the pressing system further comprises a membrane, wherein the membrane is connected to one of the pressing tools, wherein a cavity for a working medium is formed between the membrane and the pressing tool connected thereto.

20. The pressing system according to claim 16, wherein the membrane is designed in such manner that its expansion profile (DVM) also deviates by a maximum of 3.5% from the expansion profile of the workpiece (DVW) during at least 97.5% of the expansion profile.

21. The pressing system according to claim 16, wherein the membrane is designed in such manner that its expansion profile (DVM) deviates by more than 5.0% from the expansion profile of the workpiece (DVW) during at least 7.5% of the expansion profile.

22. The pressing system according to claim 16, wherein the pressing system has a pressing plane and in that the membrane is arranged so as to be movable with respect to the pressing tool connected thereto, preferably with at least one directional component running preferably substantially parallel to the pressing plane.

23. The pressing system according to claim 16, wherein at least the first pressing tool and/or at least the second pressing tool comprises a cast iron material with a nickel content of between 36.0% and 48%, preferably of between 37.5% and 47%, quite preferably of between 39.25% and 46%, and is formed in particular at least 90%, in particular at least 98% by volume fraction, preferably integrally, therefrom.

24. The pressing system according to claim 16, wherein the cast iron material further comprises 1.0% to 5.5%, preferably 1.5% to 4.0% carbon.

25. The pressing system according to claim 16, wherein the pressing system passes through a pressing cycle for manufacturing the workpiece and the pressing cycle passes through a temperature difference of 100 K to 500 K, preferably of 170 K to 450 K, quite preferably of 190 K to 250 K, acting in the working space.

26. The pressing system according to claim 16, wherein the working space is defined by a first spatial axis (X), a second spatial axis (Y) and a third spatial axis (Z) and is designed at least in the direction of one of the spatial axes (X, Y, Z) along a distance (L) of at least 1.3 m, preferably at least 3.5 m, quite preferably at least 5 m, more preferably at least 8 m and quite particularly preferably at least 10.5 m.

27. The pressing tool for use in a press with a first pressing tool and a second pressing tool, wherein the first pressing tool and the second pressing tool can be moved relative to one another to form a working space, and wherein the pressing tool is designed in such manner that it can be brought into operative connection with a pressure generating device to generate a pressure profile acting on the workpiece located in the working space and a temperature generating device for generating a temperature profile acting on the workpiece located in the working space, wherein it is designed for a pressing system according to claim 16.

28. A method for manufacturing a workpiece, comprising the following steps:
Providing a press with a pressure generating device and a temperature generating device
Providing a workpiece (to be produced)
Inserting the workpiece into a working region to form a pressing system
Closing the press
Applying pressure (p) and/or temperature (T) to workpiece
Opening the press, wherein the workpiece passes through an expansion profile (DVW) as a function of the pressure profile acting in the working space and the temperature profile acting in the working space, wherein the first pressing tool and the second pressing tool pass through a respective expansion profile (DVP1, DVP2) as a function of the pressure profile acting in the working space and the temperature profile acting in the working space and the first pressing tool and/or the second pressing tool are designed in such manner that their expansion profile (DVP1, DVP2) deviates by a maximum of 3.5% from the expansion profile (DVW) of the workpiece during at least 97.5% of the expansion profile.

29. The method according to claim 28, wherein a pressing system is used to carry out the method.

30. The method according to claim 29, wherein the workpiece to be formed is inserted into the press, in particular into the working space, in the form of a plurality of prepregs in a fixed aggregate state.
